(19) United States
(12) Patent Application Publication
(10) Pub. No.: US 2026/0266443 A1
(43) Pub. Date: Sep. 10, 2026

(54) SOLAR LED LIGHT FLOOR THAT CAN BE SPLICED

(71) Applicant: Bo Zhao, Shenzhen (CN)

(72) Inventor: Bo Zhao, Shenzhen (CN)

(21) Appl. No.: 19/662,161

(22) Filed: Apr. 29, 2026

(51) Int. Cl. F21S 9/03; F21S 8/00; F21S 8/02; F21V 15/01; F21V 17/10; F21V 21/08; F21V 23/00; F21V 23/04; F21Y 115/10

(52) U.S. Cl. CPC F21S 9/035; F21S 8/022; F21S 8/032; F21V 15/01; F21V 17/10; F21V 21/0824; F21V 23/002; F21V 23/04; F21Y 2115/10

(57) ABSTRACT

Provided is a solar LED light floor, which includes a first installation slot provided on a front side of a floor body, a solar panel is clamped in the first installation slot. A power supply component is fixedly provided on a rear side of the floor body opposite the first installation slot; an edge of a front of the floor body is detachably connected to the buckle plate, there are insertion slots at four corners of the back side of the floor body. The insertion slots are adapted to connect with a ground plug, which not only provides a stable power access path for the floor body, but also facilitates the installation and disassembly process. The present disclosure collects solar energy through the solar panel and stores and converts it through the power supply component on the back side, thereby achieving a green and environmentally friendly energy supply method.

### TECHNICAL FIELD

The present disclosure relates to the field of floor technologies, and in particular, to a solar light-emitting diode, (LED) light floor that can be spliced.

### BACKGROUND

With the rapid development of outdoor landscape lighting and courtyard decoration, solar LED flooring has been widely used due to its advantages of energy saving, environmental protection, and no need for wiring.

The existing solar LED flooring is mostly an integrated fixed structure, which generally has problems such as inconvenient splicing and installation, weak connection, and cumbersome disassembly and maintenance. At the same time, the back of the floor lacks reasonable reinforcement ribs and support structures, resulting in insufficient overall strength and easy deformation and cracking during long-term use. The internal light wires and power supply components have no regular wiring space, and the wiring is messy, prone to wear and poor heat dissipation, which can easily cause short circuit faults. In addition, the connection structure between the buckle plate and the panel is simple, and it is prone to loosening, curling, and water ingress after long-term trampling. Moreover, most products rely solely on solar energy for power supply, and the stability of power supply is poor in rainy weather, which cannot meet the long-term reliable outdoor use needs.

Therefore, there are obvious deficiencies in the current technology in terms of splicing convenience, structural strength, wiring standardization, connection firmness, and power supply stability. There is an urgent need for a solar LED lamp floor that can be quickly spliced, structurally stable, easy to disassemble and assemble, and has reliable power supply.

To address the aforementioned technical issues, the purpose of the present disclosure is to provide a solar LED light floor that can be spliced, including: a buckle plate and a rectangular floor body, and further includes a power supply component, a solar panel, a ground plug, and an insertion slot; a front side of the floor body is provided with a first installation slot, and the solar panel is clamped in the first installation slot; the power supply component is fixed on a back side of the floor body that is opposite to the first installation slot; an edge of the front side of the floor body is detachably connected to the buckle plate, and there are insertion slots at four corners of the back side of the floor body, and insertion slots are adaptively connected to the ground plug.

In some embodiments of the present disclosure, the back side of the floor body is uniformly arranged with longitudinal vertical bars and transverse vertical bars that are integrated and crossing arranged, and a support column is provided at an intersection of the longitudinal vertical bars and transverse vertical bars; a height of the support column is higher than that of the longitudinal vertical bars and transverse vertical bars, and the height of the support column is flushed with a height of the power supply component; the longitudinal vertical bars and transverse vertical bars do not pass through the power supply component; multiple sets of cable slots are provided within areas enclosed by the longitudinal vertical bars and transverse vertical bars.

In some embodiments of the present disclosure, the floor body is provided with a communicated second installation slot facing outward along a periphery of the floor body, and multiple sets of relatively misaligned clamp slots are respectively provided on inner and outer sides of the second installation slot; the buckle plate is provided with multiple sets of relatively misaligned clamp hooks on inner and outer sides, and the corresponding clamp slots and clamp hooks are buckled when the buckle plate is connected to the floor body.

In some embodiments of the present disclosure, the power supply component includes a storage box, a battery slot, a battery, support ribs plate, a back plate, and a screw hole; the back side of the floor body is integrally formed with the storage box, and an upper part of the storage box is horizontally provided with the battery slot; where the battery slot is detachably clamped with the battery, and two support rib plates are spaced apart at a lower part of the storage box; multiple sets of corresponding screw holes are uniformly provided at corners of the storage box and the back plate, and the back plate and the storage box are fixedly connected by bolts inside the screw holes .

In some embodiments of the present disclosure, the buckle plate includes four sets of buckle strips that can be spliced into rectangles, and when the buckle plate is fastened into the second installation slot, a receiving cavity is formed between the buckle plate and a bottom of the second installation slot.

In some embodiments of the present disclosure, a switch button is provided on the back plate, and the switch button is bidirectionally electrically connected to the battery.

In some embodiments of the present disclosure, the battery is bidirectionally electrically connected to the solar panel.

In some embodiments of the present disclosure, multiple anti-slip ribs are uniformly arranged on the floor body.

Compared with the existing technology, the present disclosure has the following beneficial effects.

The present disclosure provides the first installation slot on the front side of the floor body, in which the solar panel is clamped. The power supply component is fixed on the back side of the floor body that is opposite to the first installation slot; the edge of front side of the floor body is detachably connected to the buckle plate, and there are insertion slots at the four corners of the back side of the floor body. The insertion slots are adapted to connect with the ground plug, which not only provides a stable power access path for the floor body, but also facilitates the installation and disassembly process. The present disclosure collects solar energy through the solar panel and stores and converts it through the power supply component on the back side, thereby achieving a green and environmentally friendly energy supply method. When the solar energy collection is insufficient in rainy weather, an external power source can be used to supplement the battery, ensuring that the normal lighting function of the floor is not affected and suitable for outdoor courtyard use.

The present disclosure uniformly arranges integrated and crossing longitudinal and transverse vertical bars on the back side of the floor body, and the support column is provided at the intersection of the longitudinal and transverse vertical bars. The height of the support column is higher than that of the longitudinal and transverse vertical bars, and the height of the support column is flush with the height of the power supply component. The longitudinal and transverse vertical bars do not pass through the power supply component, which can ensure support stability while avoiding compression or interference of the longitudinal and transverse vertical bars on the power supply component. There are multiple sets of cable trays in the areas enclosed by vertical and horizontal bars, which provide convenience for the sorting and fixing of light string lines and ensure the neat and orderly layout of the back side lines of the floor body. The floor body is provided with the communicated second installation slot facing outward along the periphery, and multiple sets of relatively misaligned clamp slots are provided on inner and outer sides of the second installation slot. There are multiple sets of relatively misaligned hooks on inner and outer sides of the buckle plate. When the buckle plate is connected to the floor body, the corresponding clamp slots and hooks are engaged, which improves the firmness and tightness of the connection between the floor body and the buckle plate, thereby effectively preventing loosening or displacement during use. To provide at least two wiring forms for users to choose from: one is to arrange them in a rectangular shape along the hooks of the buckle plate; the other one is to lay it along the longitudinal and transverse vertical bars and around the support columns. The layout paths of two types of string wires can ensure that the string wires are not exposed, and a controller has sufficient heat dissipation.

### BRIEF DESCRIPTION OF DRAWINGS

FIG. 1 is an overall structural schematic diagram provided by the present disclosure.

FIG. 2 is a first explosives schematic diagram provided by the present disclosure.

FIG. 3 is a second explosive schematic diagram provided by the present disclosure.

FIG. 4 is a rear-view schematic diagram provided by the present disclosure.

FIG. 5 is a front view schematic diagram provided by the present disclosure.

### DESCRIPTION OF EMBODIMENTS

In the present disclosure will be further explained in combination with the accompanying drawings and specific embodiments.

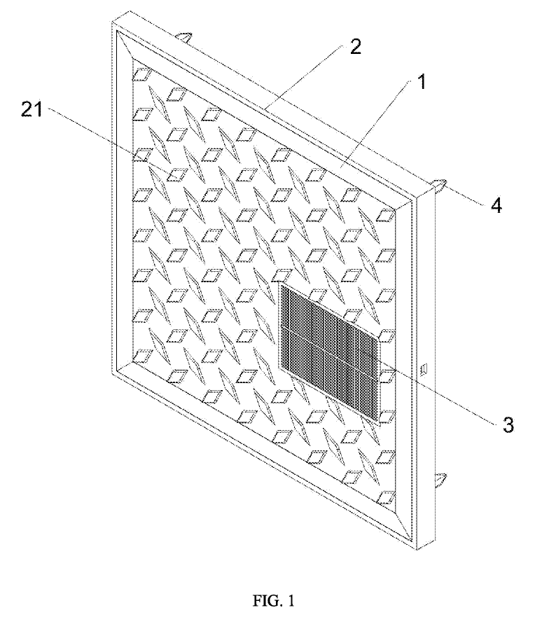

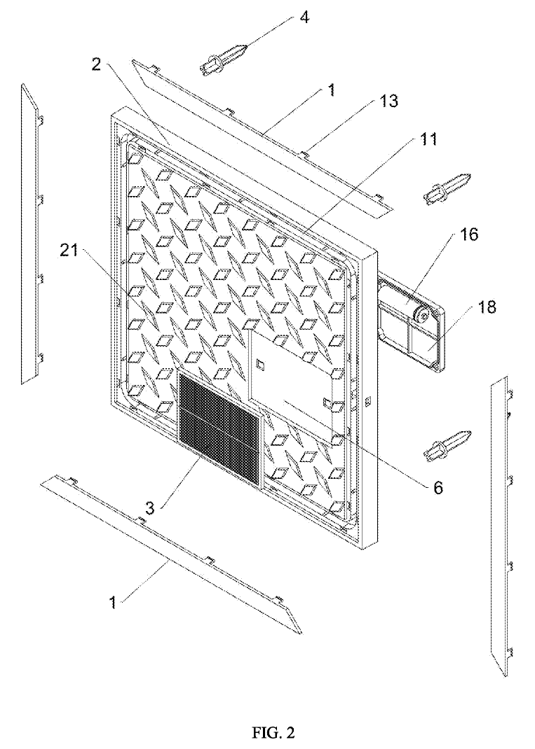

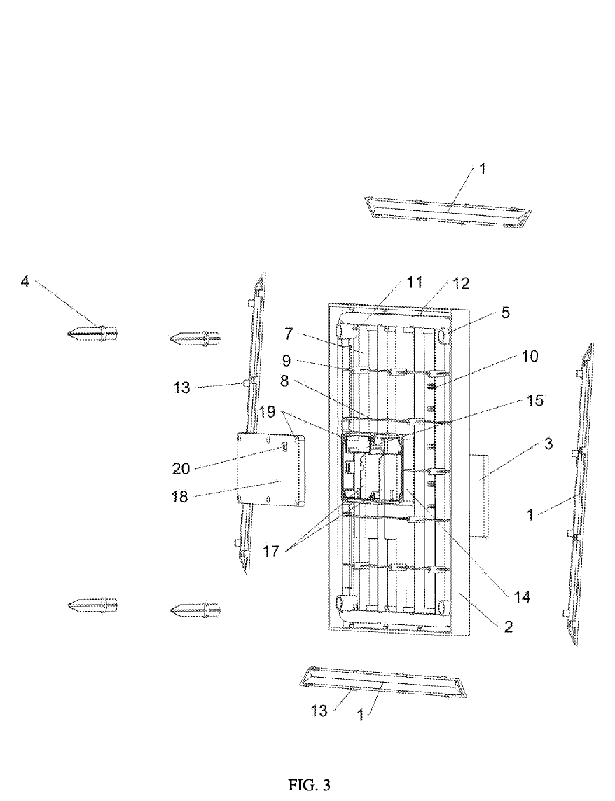

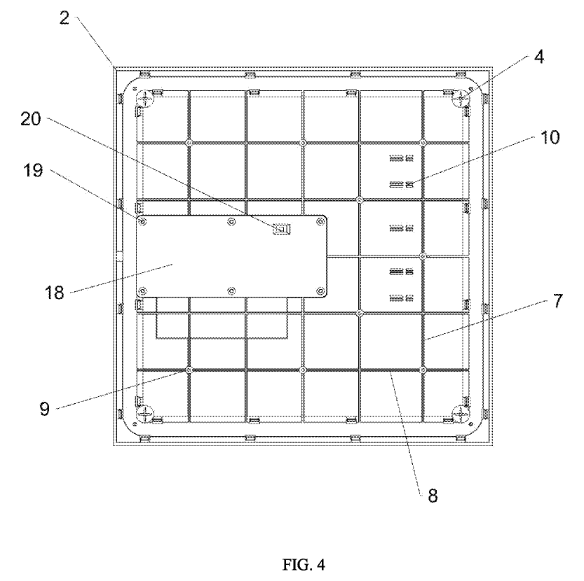

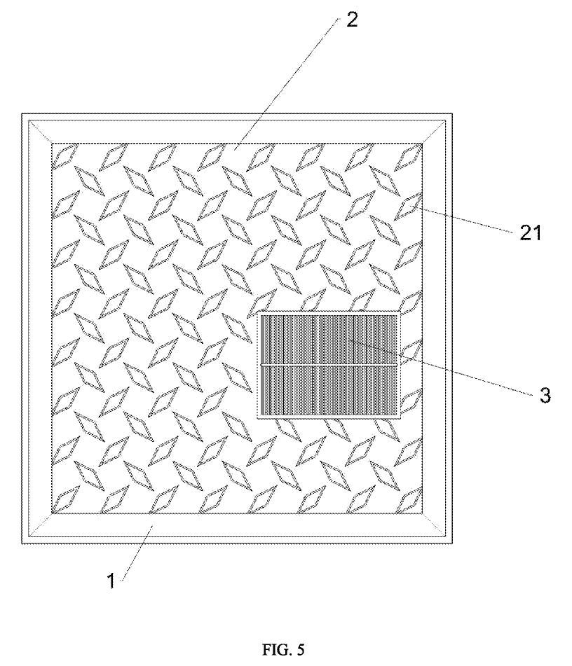

As shown in FIGS. 1-5, a solar LED light floor that can be spliced includes a buckle plate 1, a floor body 2, a solar panel 3, a ground plug 4, an insertion slot 5, a first installation slot 6, longitudinal vertical bars 7, transverse vertical bars 8, a support column 9, cable slots 10, a second installation slot 11, clamp slots 12, a clamp hook 13, a storage box 14, a battery slot 15, a battery 16, support rib plates 17, a back plate 18, a screw hole 19, a switch button 20, and anti-slip ribs 21.

In the description of the present disclosure, unless otherwise specified, “multiple” means two or more; terms “up”, “down”, “left”, “right”, “inside”, “outside”, “front end”, “back end”, “head”, “tail”, etc. indicate orientation or positional relationships based on the orientation or positional relationships shown in the accompanying drawings, only for the convenience of describing the present disclosure and simplifying the description, and do not indicate or imply that the device or element referred to must have a specific orientation, be constructed and operated in a specific orientation, and therefore cannot be understood as limiting the present disclosure. Besides that, terms “first”, “second”, “third”, etc. are only used for descriptive purposes and cannot be understood as indicating or implying relative importance.

In the description of the present disclosure, it should be noted that unless otherwise specified and limited, terms “connected to” and “connected with” should be broadly understood, for example, it can be a fixed connection, a detachable connection, or an integral connection; it can be a mechanical connection or an electrical connection; it can be directly connected or indirectly connected through an intermediate medium. For those skilled in the art, specific meanings of the above terms in the present disclosure can be understood in specific situations.

As shown in FIGS. 1- 5, the solar LED light floor that can be spliced includes the buckle plate 1, the rectangular floor body 2, a power supply component, the solar panel 3, the ground plug 4, and the insertion slot 5. The floor body 2 is uniformly arranged with multiple anti-slip ribs 21, and surfaces of the anti-slip ribs 21 are processed with frosted treatment, which have dual effects of night reflection and anti-slip in rainy days, and can also improve the foot comfort during walking, ensuring walking safety. A front side of the floor body 2 is provided with the first installation slot 6, in which the solar panel 3 is clamped. The power supply component is fixed on a back side of the floor body 2 that is opposite to the first installation slot 6. An edge of a front side of the floor body 2 is detachably connected to the buckle plate 1, and there is the insertion slot 5 on the floor body 2. The ground plug 4 is adapted and connected to the insertion slot 5. The buckle plate 1 and the floor body 2 are detachably connected by a frame, and are compatible with the internal ground plug 4 and the insertion slot 5 for connection, thereby achieving a stable mechanical connection, and completing an electrical docking positioning. The mechanical and electrical connections are completed synchronously, thus simplifying the splicing steps and ensuring reliable connection and stable contact. The present disclosure collects light energy through the solar panel 3 and stores and converts it through the power supply component on the back side, thus achieving a green and environmentally friendly energy supply method. When solar energy collection is insufficient in rainy weather, an external power source can be used to supplement the battery 16, ensuring that the normal lighting function of the floor is not affected and suitable for outdoor courtyard use.

The back side of the floor body 2 is uniformly arranged with longitudinal vertical bars 7 and the transverse vertical bars 8 that are integrated and crossing arranged. At an intersection of the longitudinal vertical bars 7 and the transverse vertical bars 8, there is a support column 9. A height of the support column 9 is higher than that of the longitudinal vertical bars 7 and transverse vertical bars 8, and the height of the support column 9 is flush with the height of the power supply component. The longitudinal vertical bars 7 and transverse vertical bars 8 do not pass through the power supply component, which can ensure support stability and avoiding compression or interference of the longitudinal vertical bars 7 and transverse vertical bars 8 on the power supply component. There are multiple sets of cable slots 10 in areas enclosed by longitudinal vertical bars 7 and transverse vertical bars 8, which provide convenience for sorting and fixing the light string wires, ensuring a neat and orderly layout of the light string wires on the back side of the floor body 2.

The floor body 2 is provided with a communicated second installation slot 11 facing outward along a periphery of the floor body 2, and multiple sets of relatively misaligned clamp slots 12 are provided on inner and outer sides of the second installation slot 11. There are multiple sets of relatively misaligned clamp hooks 13 on inner and outer sides of the buckle plate 1, and the corresponding clamp slots 12 and clamp hooks 13 are engaged when the buckle plate 1 is connected to the floor body 2. When assembling the buckle plate 1 with the floor body 2, multiple points that are misaligned arranged are formed, resulting in a more even connection force and significantly improving the firmness and tightness of the connection, thereby effectively avoiding loosening, displacement, and edge curling problems caused by long-term trampling, thermal expansion and contraction.

The buckle plate 1 includes four sets of buckle strips that can be spliced into a rectangle. When buckle plate 1 is fastened into the second installation slot 11, a receiving cavity is formed between buckle plate 1 and a bottom of the second installation slot 11 for subsequent installation of light string wires.

All clamp hooks 13 and clamp slots 12 adopt a trapezoidal inclined guide structure. During assembly, only a light pressure on the buckle plate 1 is needed to automatically guide the buckle plate 1 into place. When disassembling, gently lift the buckle plate 1 in the opposite direction, and an inclined surface of the clamp hook 13 will retract and detach from the clamp slots 12 under force. The entire installation process does not require tools, and one user can quickly complete the assembly and power debugging of the entire floor.

Chambers for storing light string wires and a controller can be formed between the support rib plates 17, as well as between the support rib plates 17 and a side wall of the storage box 14. This figure does not show the specific structure of the light string wires and controller, which are commonly available on the market for self-purchase. In actual installation, there are at least two types of wiring forms for the light string for the user to choose from: one is to form a rectangular shape with the receiving cavity between the buckle plate 1 and the bottom of the second installation slot 11. The other one is to lay it along the longitudinal vertical bars 7 and the transverse vertical bars 8, and around the support column 9. The layout paths of the two types of string wires can ensure that the string wires are not exposed, and the controller has sufficient heat dissipation.

The power supply component includes a storage box 14, a battery slot 15, a battery 16, support rib plates 17, a back plate 18, and a screw hole 19. The back side of the floor body 2 is integrally formed with the storage box 14, and an upper part of the storage box 14 is horizontally provided with the battery slot 15. The battery 16 can be detachably clamped in the battery slot 15, and two support rib plates 17 are spaced apart at a lower part of the storage box 14. Multiple sets of corresponding screw holes 19 are uniformly arranged at corners of the storage box 14 and the back plate 18, and the back plate 18 and the storage box 14 are fixedly connected by bolts inside the screw holes 19. Due to the standard specification of screw hole 19, which is compatible with common bolts on the market, the present disclosure does not distinguish and mark the screw holes 19 of the storage box 14 and the back plate 18. The standardized design of screw hole 19 greatly reduces the cost of later maintenance and replacement, and simplifies the installation process, allowing nonprofessionals to quickly complete disassembly and assembly operations, thereby further improving the universality and maintenance efficiency of the present disclosure.

On the back plate 18, there is the switch button 20, and the switch button 20 is bidirectionally connected to the battery 16. The battery 16 is bidirectionally electrically connected to the solar panel 3. The electricity collected by the solar panel 3 can be stored in the battery 16. When the ambient light is insufficient, the battery 16 can provide stable power support for LED light group, ensuring that the floor still has good lighting effect at night or in dim environments. The switch button 20 facilitates the user to manually controlling the opening and closing for debugging according to actual needs, thereby enhancing the convenience and flexibility of use.

The adaptive connection between the ground plug 4 and the insertion slot 5 not only provides a stable power access path for the floor body 2 but also facilitates the installation and disassembly process.

The longitudinal vertical bars 7 and transverse vertical bars 8 that are crossing arranged at the back side of the floor body 2 effectively enhance the overall structural strength of the floor.

The second installation slot 11 that is communicated at the back side periphery of the floor body 2, as well as the clamp slots 12 on inner and outer sides of the groove that are relatively misaligned, cooperate with the clamp hooks 13 that are relatively misaligned arranged on the inner and outer sides of the buckle plate 1 to further enhance the firmness and tightness of a connection between the floor body 2 and the buckle plate 1, thereby effectively preventing loosening or displacement during use.

The overall working principle of the present disclosure is during installation, it is necessary to first check whether the clamp slots 12 and clamp hook 13 of each splicing unit are intact, and whether there are foreign objects on the surface that affect splicing. When installing, a first buckle plate 1 is placed on a flat surface to ensure it is stable and not shaking. Then an adjacent buckle plate 1 is picked up, it is aligned with positions of the clamp slot 12 and the clamp hook 13, and let the trapezoidal inclined guide structure naturally fit. Gently press the edge of the buckle plate 1 with hands, and hear a “click” sound, which means that the clamp hook 13 has been precisely engaged in the clamp slots 12, thereby achieving seamless docking. The assembly of all floor units in sequence is completed according to this method, paying attention to maintaining the overall flatness of the ground during the process to avoid deviations in subsequent splicing caused by the tilting of individual floor units. After assembly, the controller is connected to the solar panel 3 and the battery 16. If it is the first time using or the battery 16 is low, the user can first charge the battery 16 through an external power source. After the battery is fully charged, the solar panel 3 is turned towards the direction of sufficient sunlight to ensure that it can effectively collect light energy. During daily use, there is no need for frequent maintenance, just regularly cleaning the dust and debris on the surface of the solar panel 3 to ensure the efficiency of light energy conversion. When it is necessary to replace a damaged floor, simply lift the buckle plate 1 of a damaged floor in reverse, and the inclined surface of the clamp hook 13 will retract under force to easily detach from the clamp slots 12. After replacing a new unit, follow the installation steps to reassemble it. The entire replacement process also does not require tools and is easy to operate.

The above embodiments are only preferred embodiments of the present disclosure

and cannot be used to limit the scope of the present disclosure. Therefore, modifications, equivalent changes, improvements, etc. made within the scope of the present disclosure still fall within the scope of the present disclosure.

What is claimed is:

1. A solar LED light floor that can be spliced, comprising: a buckle plate and a rectangular floor body, and further comprises a power supply component, a solar panel, a ground plug, and an insertion slot;
a front side of the floor body is provided with a first installation slot, and the solar panel is clamped in the first installation slot; the power supply component is fixed on a back side of the floor body that is opposite to the first installation slot; an edge of the front side of the floor body is detachably connected to the buckle plate, and there are insertion slots at four corners of the back side of the floor body, and insertion slots are adaptively connected to the ground plug.

2. The solar LED light floor that can be spliced according to claim 1, wherein the back side of the floor body is uniformly arranged with longitudinal vertical bars and transverse vertical bars that are integrated and crossing arranged, and a support column is provided at an intersection of the longitudinal vertical bars and transverse vertical bars; a height of the support column is higher than that of the longitudinal vertical bars and transverse vertical bars, and the height of the support column is flushed with a height of the power supply component; the longitudinal vertical bars and transverse vertical bars do not pass through the power supply component; multiple sets of cable slots are provided within areas enclosed by the longitudinal vertical bars and transverse vertical bars.

3. The solar LED light floor that can be spliced according to claim 2, wherein the floor body is provided with a communicated second installation slot facing outward along a periphery of the floor body, and multiple sets of relatively misaligned clamp slots are respectively provided on inner and outer sides of the second installation slot; the buckle plate is provided with multiple sets of relatively misaligned clamp hooks on inner and outer sides, and the corresponding clamp slots and clamp hooks are buckled when the buckle plate is connected to the floor body.

4. The solar LED light floor that can be spliced according to claim 3, wherein the power supply component comprises a storage box, a battery slot, a battery, support ribs plate, a back plate, and a screw hole; the back side of the floor body is integrally formed with the storage box, and an upper part of the storage box is horizontally provided with the battery slot; wherein the battery slot is detachably clamped with the battery, and two support rib plates are spaced apart at a lower part of the storage box; multiple sets of corresponding screw holes are uniformly provided at corners of the storage box and the back plate, and the back plate and the storage box are fixedly connected by bolts inside the screw holes.

5. The solar LED light floor that can be spliced according to claim 4, wherein the buckle plate comprises four sets of buckle strips that can be spliced into rectangles, and when the buckle plate is fastened into the second installation slot, a receiving cavity is formed between the buckle plate and a bottom of the second installation slot.

6. The solar LED light floor that can be spliced according to claim 4, wherein a switch button is provided on the back plate, and the switch button is bidirectionally electrically connected to the battery.

7. The solar LED light floor that can be spliced according to claim 5, wherein the battery is bidirectionally electrically connected to the solar panel.

8. The solar LED light floor that can be spliced according to claim 5, wherein multiple anti-slip ribs are uniformly arranged on the floor body.
